(19) United States
(12) Patent Application Publication
(10) Pub. No.: US 2020/0081319 A1
(43) Pub. Date: Mar. 12, 2020

(54) OPTICAL SYSTEM

(71) Applicant: Santec Corporation, Aichi (JP)

(72) Inventors: Kouki Totsuka, Aichi (JP); Masahiro Kawasugi, Aichi (JP); Takahide Sakaidani, Aichi (JP); Keiji Isamoto, Aichi (JP)

(73) Assignee: Santec Corporation, Aichi (JP)

(21) Appl. No.: 16/567,636

(22) Filed: Sep. 11, 2019

(30) Foreign Application Priority Data
Sep. 11, 2018 (JP) 2018-169656

(51) Int. Cl. G02F 1/35

(52) U.S. Cl. CPC G02F 1/3534; G02F 2203/11

(57) ABSTRACT

An optical system includes: a difference-frequency-light generator that multiplexes output lights from a signal-light light source and an excitation-light light source and inputs the output lights to a nonlinear optical material to generate and output a difference-frequency light having a wavenumber that corresponds to a wavenumber difference between light from the signal-light and from the excitation-light light source, where one of the signal-light source or the excitation-light source is a wavelength-sweeping light source; a splitter that splits a portion of light output from the wavelength-sweeping light source into a first and a second reference light; and an equal-wavenumber-signal generator that receives the first reference light, via an interferometer, to generate and output an equal-wavenumber signal that fluctuates in equal wavenumber intervals according to wavelength sweeping of the wavelength-sweeping light source.

### TECHNICAL FIELD

The present invention relates to an optical system.

### BACKGROUND

Systems that irradiate light to a measurement target gas while wavelength sweeping and measure an absorbance of the irradiated light to perform component analysis of the gas are already known (for example, see patent literature 1). As the irradiated light, a mid-infrared light of a wavelength of, for example, 2.5 μm to 4 μm is used. The mid-infrared wavelength region exhibits different absorption spectra according to molecule type and is therefore an important wavelength region for identifying chemical substances.

In recent years, measuring an optical absorption of a measurement target gas in this mid-infrared wavelength region to analyze component concentrations of a gas from an internal combustion engine or an industrial process that is a source of greenhouse gases is being proposed. To measure an absorption spectrum of the gas in real time and analyze the component concentrations and a composition of the gas, it is important to broadly and quickly sweep the mid-infrared wavelength and to sweep repeatedly in short periods.

Reference modes of vibration (i.e., fundamental vibration modes) of many types of hydrocarbon molecules are present in a wavelength band of mid-infrared light, particularly near a wavelength of 3 μm to 3.5 μm, and present in this band are absorption lines whereat absorption by methane, ethane, propane, butane, acetylene, and the like is one hundred times greater than at vibrational harmonics present at wavelengths no greater than 3 μm. Because of this, the wavelength band of 3 μm to 3.5 μm is very useful in detecting trace amounts of gases with high sensitivity.

To measure an absorption spectra of these gases, vibrational and rotational levels need to be able to be identified in order to specify molecule type. Moreover, a linewidth of a light source needs to be narrower than a width of the absorption spectrum lines, which are due to transitions between the vibrational and rotational levels. In the case of methane, vibrational and rotational spectral intervals of the molecule are 300 GHz and a linewidth of each absorption line is about 300 MHz at room temperature due to Doppler broadening such that a linewidth of an irradiated light may be no greater than 300 MHz.

To meet this condition, an oscillation mode of a laser light as the irradiated light may be a single mode and for continuous (mode-hop-free) wavelength sweeping may be able to be realized. This is because a wavelength discontinuity arises in the absorption spectrum if continuous wavelength sweeping cannot be realized.

As wavelength-sweeping light sources that meet these conditions (single mode and mode-hop free) and can realize wavelength sweeping of mid-infrared light, there are, for example, light sources that use a quantum cascade laser (QCL), an optical parametric amplifier (OPA) that uses a nonlinear optical process, and difference frequency generation (DFG). However, because systems using these wavelength-sweeping light sources have a small sweepable wavelength band, a slow wavelength sweep rate, and a low wavelength-sweep repeating frequency, repeating high-speed sweeping in short periods to realize real-time measurement of the gas is difficult.

For example, as disclosed in patent literature 2, in a system that adopts a QCL as the wavelength-sweeping light source, to avoid mode hopping during wavelength sweeping, wavelength sweeping is controlled using a motor. This prevents high-speed wavelength sweeping at a wavelength-sweep repeating frequency over 10 Hz.

Art is also known of using a distributed feedback (DFB) laser using a diffraction-grating structure for a cavity inside a semiconductor laser to perform wavelength sweeping by utilizing a cavity length change due to a thermal expansion effect arising from temperature adjustment. However, such art using thermal expansion has disadvantages such as a slow wavelength sweep rate and a narrow wavelength sweep range limited to less than 10 nm.

In systems utilizing difference frequency generation (DFG) as well, in a conventional system that realizes wavelength sweeping by driving an optical component with a large mass by a motor, it is difficult to increase a wavelength-sweep repeating frequency and a wavelength sweep rate due to a drive speed of the motor, inertia of a drive target, and the like.

As a light source that can perform high-speed wavelength sweeping, a MEMS tunable VCSEL (vertical-cavity surface-emitting laser) that realizes wavelength sweeping by driving one face of a cavity by a MEMS (microelectromechanical system) is known (see patent literature 3). However, according to the prior art, this light source cannot be utilized for spectrometric purposes. That is, while a MEMS tunable VCSEL can perform high-speed wavelength sweeping, the prior art cannot determine the wavelengths of the sweeping process with precision such that spectral data of wavenumber versus absorbance cannot be generated with precision.

### PATENT LITERATURE

[Patent Literature 1] JP 2011-203376 A

[Patent Literature 2] US 2007/0030865 A1

[Patent Literature 3] JP 2010-161253 A

### SUMMARY

As discussed above, high-speed wavelength sweeping in optical systems is difficult in optical systems and, even if high-speed wavelength sweeping is achieved, wavelengths in a sweeping process may not be able to be determined with high precision. Therefore, one or more embodiments of the present invention may provide an optical system than can determine with high precision a wavelength swept at high speed.

An optical system of one or more embodiments of the present invention is provided with a difference-frequency-light generation unit (a difference-frequency-light generator), a splitter unit (splitter), an equal-wavenumber-signal generation unit (an equal-wavenumber-signal generator), and a reference-signal generation unit (a reference signal generator). The difference-frequency-light generation unit multiplexes output lights from a signal-light light source and an excitation-light light source and input this to a nonlinear optical material to generate and output a difference-frequency light having a wavenumber corresponding to a wavenumber difference between the output light from the signal-light light source and the output light from the excitation-light light source. One among the signal-light light source and the excitation-light light source is configured as a wavelength-sweeping light source.

The splitter unit is configured to split a portion of the output light from the wavelength-sweeping light source into first and second reference lights. The equal-wavenumber-signal generation unit is configured to receive the split first reference light via an interferometer that outputs an interference light corresponding to a wavelength of an input light to generate and output an equal-wavenumber signal that is an electrical signal that fluctuates in equal wavenumber intervals according to wavelength sweeping of the wavelength-sweeping light source.

The reference-signal generation unit is configured to receive the second reference light via an optical element that selectively causes an input light of a specified wavelength to pass through to generate and output an electrical reference signal when the second reference light has the specified wavelength.

By using this optical system, even in an environment where change in wavelengths of a sweeping process is not constant, from a relationship between the equal-wavenumber signal and the reference signal, a wavelength or a wavenumber of the output light from the wavelength-sweeping light source can be determined with high precision and a wavelength or the wavenumber of the difference-frequency light can be determined with high precision. In high-speed sweeping, variation is more likely to arise in change in wavelengths of a sweeping process. Using the optical system of the present invention enables an effect of such variation to be suppressed to determine a sweeping wavelength with high precision.

According to one or more embodiments of the present invention, the optical system may be further provided with a measurement unit (photodetector). The photodetector may be configured to receive the difference-frequency light from the difference-frequency-light generation unit via a measurement target to output a measurement signal indicating a reception intensity of the difference-frequency light passed through the measurement target. According to one or more embodiments of the present invention, the optical system may be applied as a system that measures an optical absorption spectrum of the measurement target.

According to one or more embodiments of the present invention, the optical system may be further provided with a recording unit (recorder). The recording unit may be configured to record the measurement signal from the photodetector, the equal-wavenumber signal from the equal-wavenumber-signal generation unit, and the reference signal from the reference-signal generation unit in association with a common temporal axis.

According to one or more embodiments of the present invention, the optical system may be further provided with an analysis unit (analyzer). The analysis unit may be configured to determine a correspondence relationship between the reception intensity and the wavelength or the wavenumber of the difference-frequency light based on the measurement signal from the photodetector, the equal-wavenumber signal from the equal-wavenumber-signal generation unit, and the reference signal from the reference-signal generation unit.

According to one or more embodiments of the present invention, the analysis unit may be configured to determine the wavelength or the wavenumber of the output light from the wavelength-sweeping light source or the difference-frequency light at times on the temporal axis based on the recorded equal-wavenumber signal and reference signal.

According to one or more embodiments of the present invention, the analysis unit may be configured to, based on a reception intensity at each time specified from the recorded measurement signal and the determined wavelength or wavenumber at each time, generate data indicating a correspondence relationship between the wavelength or the wavenumber and the intensity or an absorbance of the light passed through the measurement target. This configuration can realize an optical system that can generate optical-absorption spectral data that can undergo high-speed wavelength sweeping and is highly precisein particular, a spectrometric system.

According to one or more embodiments of the present invention, the analysis unit may be configured to reduce a noise component included in the equal-wavenumber signal by subjecting the equal-wavenumber signal to filter processing. By reducing the noise component, the wavelength or the wavenumber at each time can be determined with high precision from the equal-wavenumber signal.

According to one or more embodiments of the present invention, the wavelength-sweeping light source may be a MEMS tunable VCSEL (vertical-cavity surface-emitting laser) that realizes wavelength sweeping by driving one face of a reflecting mirror configuring a cavity by a MEMS (microelectromechanical system).

Although a MEMS tunable VCSEL can perform high-speed wavelength sweeping, normally, because change in sweeping wavelength is not constant or linear, the wavelength at each time cannot be determined with high precision with only information on an elapsed time from starting wavelength sweeping. According to the optical system of the present invention, the wavelength or the wavenumber at each time of the difference-frequency light can be determined with high precision even when high-speed wavelength sweeping is performed using the MEMS tunable VCSEL.

According to one or more embodiments of the present invention, the difference-frequency light may be a mid-infrared light. According to one or more embodiments of the present invention, the wavelength of the difference-frequency light may be within a mid-infrared wavelength range of 3 to 3.5 μm. A mid-infrared light is very useful in component analysis of many gasesfor example, component analysis of a gas including hydrocarbon molecules.

According to one or more embodiments of the present invention, a linewidth of the difference-frequency light may be no less than 1 MHz and no greater than 1 GHz. According to one or more embodiments of the present invention, a wavelength-sweep repeating frequency of the difference-frequency light may be no less than 10 Hz and no greater than 100 kHz. According to one or more embodiments of the present invention, a sweeping wavenumber range may be no less than 20 cm⁻¹ and no greater than 250 cm⁻¹.

According to one or more embodiments of the present invention, the optical element may be an optical filter that selectively causes an input light of a specified wavelength to pass through. According to one or more embodiments of the present invention, the optical element may be an optical filter configured by a dielectric multilayer film. According to one or more embodiments of the present invention, the optical filter may be a band-pass filter of a transmission wavelength width of no less than 0.1 nm and no greater than 1 nm. According to this transmission wavelength width, the reference signal can be appropriately generated based on a transmission light of the optical filter and the wavelength or the wavenumber can be determined with high precision based on the reference signal and the equal-wavenumber signal.

### BRIEF DESCRIPTION OF DRAWINGS

FIG. 1 shows a block diagram representing a configuration of an optical measurement system in accordance with one or more embodiments.

FIG. 2 shows a graph illustrating an oscillation spectrum of a MEMS tunable VCSEL in accordance with one or more embodiments.

FIG. 3 shows a graph illustrating change over time in output power from the MEMS tunable VCSEL and a wavelength in accordance with one or more embodiments.

FIG. 4 shows a graph illustrating change over time in sweeping wavelength in accordance with one or more embodiments.

FIG. 5 shows a graph illustrating a transmission intensity of a band-pass filter in accordance with one or more embodiments.

FIG. 6 shows a graph of time versus voltage illustrating an intensity measurement signal, an equal-wavenumber signal, and a reference signal in accordance with one or more embodiments.

FIG. 7 shows a flowchart of an analysis process executed by a processor in accordance with one or more embodiments.

FIG. 8 shows a diagram describing a principle of determining a wavenumber based on the reference signal and the equal-wavenumber signal in accordance with one or more embodiments.

FIG. 9 shows a diagram describing a principle of determining a time corresponding to the wavenumber in accordance with one or more embodiments.

FIG. 10 shows a graph representing a correspondence relationship between time and wavenumber in accordance with one or more embodiments.

FIG. 11 shows a diagram describing an estimation method of an intensity of a mid-infrared light in accordance with one or more embodiments.

FIG. 12 shows a graph illustrating change over time in output intensity and wavelength of the mid-infrared light in accordance with one or more embodiments.

FIG. 13 shows a graph illustrating measurement results of an absorbance by methane gas in accordance with one or more embodiments.

FIG. 14 shows a graph illustrating an optical absorption spectrum at room temperature of methane gas in accordance with one or more embodiments.

FIG. 15 shows an enlarged graph displaying the absorbance near a specified wavenumber in accordance with one or more embodiments.

FIG. 16 shows a histogram relating to wavenumber variation in accordance with one or more embodiments.

FIG. 17 shows an explanatory diagram relating to sampling at equal wavenumber intervals in accordance with one or more embodiments.

FIG. 18 shows a diagram illustrating the equal-wavenumber signal before and after executing numerical-computation filter processing in accordance with one or more embodiments.

FIG. 19 shows a flowchart of the numerical-computation filter processing executed by the processor in accordance with one or more embodiments.

FIG. 20 shows a diagram representing an FFT spectrum in accordance with one or more embodiments.

FIG. 21 shows an explanatory view relating to peak detection in accordance with one or more embodiments.

### DETAILED DESCRIPTION

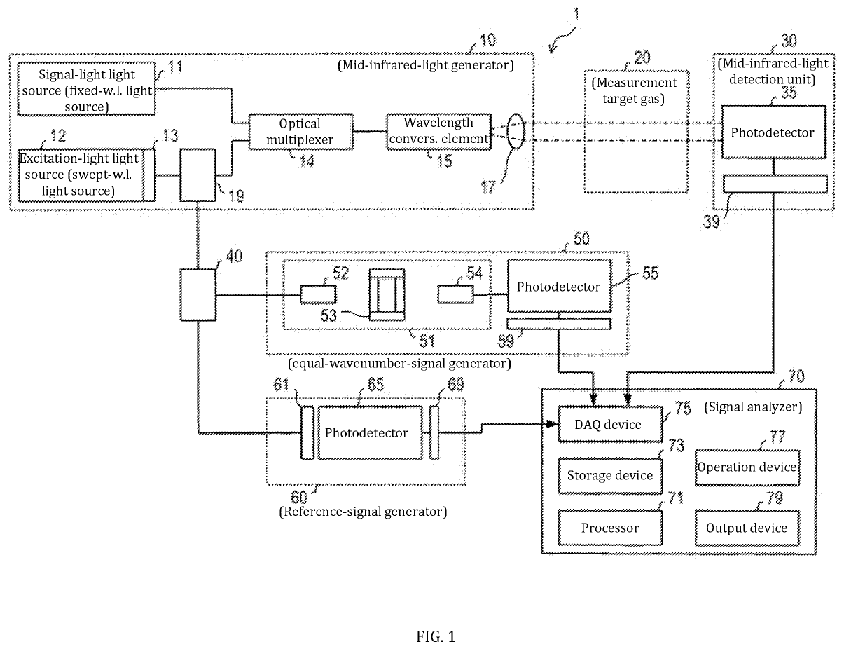

Illustrative embodiments of the present invention are described below with reference to the drawings. An optical measurement system 1 of one or more embodiments illustrated in FIG. 1 is a system for irradiating a mid-infrared light to a measurement target gas 20 to measure an absorbance of the measurement target gas 20.

This optical measurement system 1 is provided with an mid-infrared-light generation unit 10, a mid-infrared-light detection unit 30, an optical splitter 40, an equal-wavenumber-signal generation unit 50, a reference-signal generation unit 60, and a signal analysis unit 70 (analysis unit). The mid-infrared-light generation unit 10 is provided with a signal-light light source 11, an excitation-light light source 12, an optical multiplexer 14, a wavelength conversion element 15, a condenser lens 17, and an optical splitter 19. This mid-infrared-light generation unit 10 functions as a difference-frequency-light output unit.

That is, the mid-infrared-light generation unit 10 is configured to multiplex output lights from the signal-light light source 11 and the excitation-light light source 12 and input this to the wavelength conversion element 15, which includes a nonlinear optical material, to generate and output a difference-frequency light of a mid-infrared wavelength having a wavenumber corresponding to a wavenumber difference between the output light from the signal-light light source 11 and the output light from the excitation-light light source 12.

In the optical measurement system 1 of one or more embodiments described below, the signal-light light source 11 is configured as a fixed-wavelength light source and the excitation-light light source 12 is configured as a wavelength-sweeping light source. However, as another example, the signal-light light source 11 may be configured as a wavelength-sweeping light source and the excitation-light light source 12 may be configured as a fixed-wavelength light source. That is, the fixed-wavelength light source illustrated in FIG. 1 may be the excitation-light light source 12 and the wavelength-sweeping light source may be the signal-light light source 11.

The signal-light light source 11 is configured to output a laser light of a fixed wavelength of, for example, a 1.5 μm band as a signal light. Examples of the signal-light light source 11 include a wavelength-stabilized DFB laser and a fiber laser. An optical-fiber amplifier for amplifying a signal-light output intensity may be disposed at a stage after output of the signal-light light source 11. A wavelength locking module that detects light passed through an optical element such as an etalon that monitors the wavelength of the signal-light light source and provides feedback on a current and a temperature of the signal-light light source to stabilize the wavelength may be added.

The excitation-light light source 12 is configured to output a laser light of, for example, a wavelength-swept 1.06 μm band as an excitation light. Specifically, the excitation-light light source 12 is configured by a MEMS tunable VCSEL. “MEMS” is an abbreviation of “microelectromechanical system,” and “VCSEL” is an abbreviation of “vertical-cavity surface-emitting laser.” The MEMS tunable VCSEL realizes wavelength sweeping by driving one face of a reflecting mirror configuring a cavity by a MEMS.

Examples of the MEMS tunable VCSEL include a MEMS tunable VCSEL combining a half VCSEL and a MEMS diaphragm mirror driven at high speed. Prior-art literature (patent literature 3: JP 2010-161253 A) discloses a MEMS tunable VCSEL provided with an InP substrate for outputting light of a 1.5 μm band. By replacing the InP substrate with a GaAs semiconductor substrate in this MEMS tunable VCSEL, a MEMS tunable VCSEL of a 1.06 μm band can be configured.

The MEMS tunable VCSEL is provided with an optical cavity that interposes an active layer of the VCSEL between a high-reflectance mirror on a VCSEL side and a high-reflectance mirror on a MEMS side. Current flowing through the VCSEL excites the active layer and generates naturally emitted light (spontaneous emission light), and the light reciprocates between the high-reflectance mirror on the VCSEL side and the high-reflectance mirror on the MEMS side. When the light passes through the active layer, the light is amplified, realizing laser oscillation.

By displacing the MEMS diaphragm mirror that includes the high-reflectance mirror in a central portion, a cavity length—defined as an interval between the high-reflectance mirror on the VCSEL side and the high-reflectance mirror on the MEMS side—changes, changing an oscillation wavelength. By shortening the cavity length, a free spectral range (FSR)—a longitudinal mode interval of the cavity—can be widened, a cavity longitudinal mode in a laser-oscillation effective gain wavelength range of the active layer can be made to be only one in number, and a variable wavelength range specified by the free spectral range can be increased.

For example, when the interval between the high-reflectance mirror on the MEMS side and the high-reflectance mirror on the VCSEL side is made to be about 8 μm, a free spectral range at a 1.06 μm band can be made to be about 70 nm; when the free spectral range is no less than the laser-oscillation effective gain wavelength range of the active layer, the oscillation wavelength can be changed for all gain wavelengths of the active layer. At this time, an oscillation longitudinal mode order is 15; by spatially moving the MEMS diaphragm mirror by no more than 525 nm to change the interval between the mirrors, continuous wavelength sweeping wherein the next order does not appear is possible.

In relation to a spatial region of the active layer excited by a current injection method, by maximizing a spatial overlap of a cavity fundamental mode specified by the high-reflectance mirror on the VCSEL side and the high-reflectance mirror on the MEMS side, a transverse mode that causes laser oscillation can be made into a single mode. Restricting this transverse mode and restricting the longitudinal mode by a short cavity length enables mode-hop-free wavelength tuning in single longitudinal and transverse modes.

In the case of an optical pump method of exciting the active layer by light, adjusting a focal diameter of the light exciting the active layer enables control of the spatial region wherein the active layer is excited; like the current injection method, an overlap with a spatial mode of the cavity can be maximized to realize longitudinal and transverse single-mode laser oscillation.

Because an average output light intensity from the MEMS tunable VCSEL of longitudinal and transverse single-mode oscillation is weak, at no greater than several mW, an optical amplification device 13 such as a semiconductor optical amplifier (SOA) for outputting a stronger mid-infrared light may be disposed at a stage after output of the MEMS tunable VCSEL, in which case the output can be amplified to a light output intensity of several ten mW. Another optical-fiber amplifier may be disposed at a stage after output of the SOA to amplify the light output intensity.

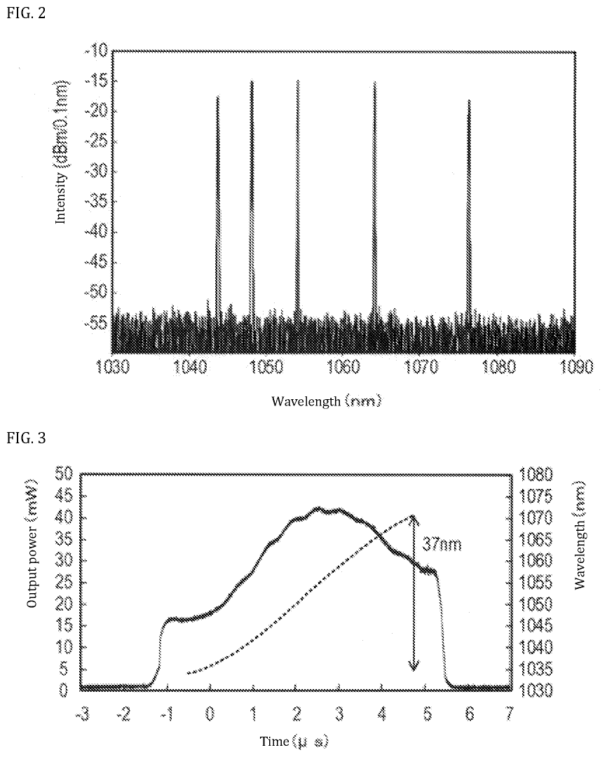

According to a test by the present disclosers, changing a constant-voltage setting applied to a MEMS of a MEMS tunable VCSEL of the above configuration enabled a laser oscillation wavelength to be changed, and a 32 nm variable wavelength range was obtained. As illustrated in FIG. 2, in this MEMS tunable VCSEL, no side modes were observed until about 40 dB below oscillation peaks, and a cavity transverse mode was also suppressed by no less than about 40 dB relative to a fundamental mode. FIG. 2 shows a graph illustrating an oscillation spectrum of the MEMS tunable VCSEL having wavelength (nm) as the horizontal axis and output light intensity from the MEMS tunable VCSEL (dBm/0.1 nm) as the vertical axis.

The graph shown in FIG. 3 illustrates change over time of output power and the wavelength of the light from the MEMS tunable VCSEL obtained from a test of driving the MEMS in the above MEMS tunable VCSEL by a voltage signal of 100 kHz. In this test, the optical amplification device 13 is disposed at a stage after the MEMS tunable VCSEL to amplify an optical signal. In the graph, the solid line represents a trajectory of the output power and the dashed line represents a trajectory of the wavelength. In the graph, the horizontal axis corresponds to a temporal axis, the right vertical axis corresponds to a wavelength axis, and the left vertical axis corresponds to an output power axis.

In this test, wavelength sweeping is realized in a range of 37 nm centered at 1052 nm at a drive frequency of 100 kHz. In one or more embodiments, when wavelength sweeping is being performed from a long wavelength to a short wavelength, a current flowed through the optical amplification device 13 is cut off so a state is set wherein there is no light output. However, if the current flowed through the optical amplification device 13 is not cut off, wavelength sweeping from a long wavelength to a short wavelength can also be output, enabling output of wavelength sweeping of not only from a short wavelength to a long wavelength but also from a long wavelength to a short wavelength. In this situation, wavelength sweeping is possible at 200 kHz, twice the 100 kHz that is a mechanical operating frequency of the MEMS diaphragm mirror.

The optical multiplexer 14 is configured to multiplex the signal light of the fixed wavelength transmitted from the signal-light light source 11 through optical fibers and the wavelength-sweeping excitation light transmitted from the excitation-light light source 12 through optical fibers. The signal light and the excitation light multiplexed by the optical multiplexer 14 are transmitted to the wavelength conversion element 15 through common optical fibers. Examples of the optical multiplexer 14 include a wavelength-division-multiplexing (WDM) coupler. The optical fibers may be polarization-holding fibers or single-mode fibers.

The wavelength conversion element 15 is provided with an optical waveguide disposed with a nonlinear optical material whose polarization is periodically inverted and is configured to generate and output the difference-frequency light having the wavenumber corresponding to the wavenumber difference between the input signal light and excitation light. The structure and principles of this wavelength conversion element 15 are disclosed in prior-art literature (patent literature 1: JP 2011-203376 A). Examples of the wavelength conversion element 15 include a waveguide difference frequency generation (DFG) device produced from a material such as LiNbO₃ whose polarization is periodically inverted.

A relationship between wavelength λ₄ of the difference-frequency light, a wavelength λ₄ of the signal light, and a wavelength λₚ of the excitation light is represented by the following formula (1).

$$\begin{matrix}[ Math . 1 ] & \\ \frac{1}{{λ}_{i}} = \frac{1}{{λ}_{p}} - \frac{1}{{λ}_{s}} & ( 1 )\end{matrix}$$

When a signal light of a 1.5 μm band and an excitation light of a 1.06 μm band are input to the wavelength conversion element 15, a difference-frequency light (mid-infrared light) of a 3 μm band is output from the wavelength conversion element 15.

The mid-infrared light output from the wavelength conversion element 15 passes through the condenser lens 17 and is output toward the measurement target gas 20 as parallel light. The condenser lens 17 is disposed for an object of preventing the mid-infrared light beam from spreading too far spatially.

The mid-infrared light that passes through the measurement target gas 20 is received by the mid-infrared-light detection unit 30. The mid-infrared-light detection unit 30 is provided with a photodetector 35 and an output circuit 39. The photodetector 35 is configured to output an electrical detection signal corresponding to a reception intensity of the mid-infrared light. Examples of the photodetector 35 include a mid-infrared detector that cools a material such as HgCdTe. The output circuit 39 subjects the detection signal from the photodetector 35 to current-voltage conversion and outputs this as an intensity measurement signal having voltage information according to the reception intensity of the mid-infrared light. This intensity measurement signal is input to the signal analysis unit 70.

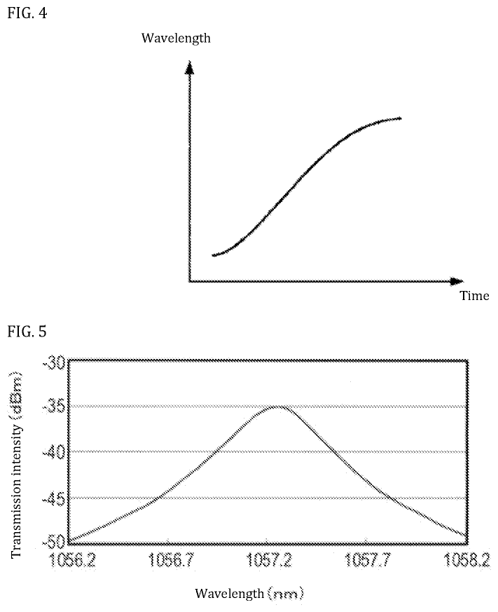

Here, change in sweeping wavelength is described. Although the wavelength of the mid-infrared light changes in conjunction with the wavelength sweeping of the excitation-light light source 12, as illustrated in FIG. 4, change over time in the wavelength of the light output from the MEMS tunable VCSEL as the excitation-light light source 12 is not linear relative to time. Because of this, the wavelength of the mid-infrared light output from the wavelength conversion element 15 also exhibits similar change over time.

The change over time in the wavelength of the output light from the MEMS tunable VCSEL is not linear because the MEMS diaphragm mirror cannot suddenly start or stop moving due to inertia. Due to the MEMS diaphragm mirror having a plurality of mechanical resonance modes and there being variation in a drive voltage of the MEMS diaphragm mirror, a trajectory of the sweeping wavelength also changes minutely with each sweep.

As is well known, in the MEMS, a phenomenon referred to as a charge-upthat is, a phenomenon of a charge accumulating on a surface of the MEMSalso occurs. This charge-up creates an apparent offset in a drive voltage of the MEMS and causes a wavelength drift phenomenon of a sweeping wavelength range moving.

In this manner, the wavelength of the light output from the MEMS tunable VCSEL cannot be easily specified to due various factors. Meanwhile, to use the MEMS tunable VCSEL as a light source for measuring an optical absorption spectrum of the gas, a correspondence relationship between the reception intensity of the mid-infrared light indicated by the intensity measurement signal from the mid-infrared-light detection unit 30 and the wavelength or wavenumber must be known. The equal-wavenumber-signal generation unit 50 and the reference-signal generation unit 60 provided by the optical measurement system 1 of one or more embodiments are used to specify this correspondence relationship.

The optical splitter 19 (see FIG. 1) provided by the mid-infrared-light generation unit 10 is configured to split a portion of the light output from the wavelength-sweeping light source (excitation-light light source 12) and provide this to the equal-wavenumber-signal generation unit 50 and the reference-signal generation unit 60. That is, the optical splitter 19 is configured to input a certain ratio of the excitation light output from the excitation-light light source 12 to the optical multiplexer 14 and input the remainder to the optical splitter 40 at a later stage.

The optical splitter 40 at the later stage is configured to further split the light split by the optical splitter 19 into first and second reference lights, inputting the first reference light to the equal-wavenumber-signal generation unit 50 and inputting the second reference light to the reference-signal generation unit 60. Examples of the optical splitters 19, 40 include a coupler.

The equal-wavenumber-signal generation unit 50 is configured to receive the input first reference light via an interferometer that outputs an interference light corresponding to a wavelength of an input light in order to output an equal-wavenumber signal that is an electrical signal that fluctuates in equal wavenumber intervals according to the wavelength sweeping of the excitation light.

Specifically, the equal-wavenumber-signal generation unit 50 is provided with a k-clock interferometer 51, a photodetector 55, and an output circuit 59. The k-clock interferometer 51 is configured to output an interference signal corresponding to the wavenumber of the wavelength-sweeping excitation light. Examples of the k-clock interferometer 51 include a MachZehnder interferometer configured by optical fibers and an etalon. Examples of the etalon include a solid or spatial etalon configuring a cavity with low-expansion glass.

The k-clock interferometer 51 illustrated in FIG. 1 is provided with an etalon 53. The etalon 53 is input with the first reference light from the optical splitter 40 via a collimator lens 52. The etalon 53 enhances a frequency component of the input light corresponding to a cavity length and outputs the interference signal. Defining a length twice as long as the cavity length of the etalon 53 (or a delay length of the interferometer) as Ld and the speed of light as c, interference fringes of equal frequency intervals of Δv=c/Ld appear in the interference signal.

The interference signal is transmitted to the photodetector 55 via a collimator lens 54. The photodetector 55 outputs an electrical detection signal according to a reception intensity of the interference signal. The output circuit 59 subjects the detection signal from the photodetector 55 to current-voltage conversion and outputs this as an equal-wavenumber signal having voltage information according to the reception intensity. The output equal-wavenumber signal is an analog k-clock signal. As a variation, the equal-wavenumber signal may be a digital k-trigger signal. A k-trigger signal is a signal output as a pulse when a k-clock signal exceeds a threshold.

The equal-wavenumber signal from the output circuit 59 is input to the signal analysis unit 70. The output circuit 59 may be configured to remove a DC component by AC coupling. That is, an equal-wavenumber signal removed of a DC component may be input to the signal analysis unit 70.

The reference-signal generation unit 60 is configured to receive the second reference light input from the optical splitter 40 via an optical filter that selectively causes an input light of a specified wavelength λ_{G} to pass through to output an electrical reference signal when the second reference light has the specified wavelength λ_{G}.

Specifically, the reference-signal generation unit 60 is provided with a band-pass filter 61 as the optical filter, a photodetector 65, and an output circuit 69. The band-pass filter 61 is disposed upstream of the photodetector 65 on a transmission path of the second reference light so the second reference light of the specified wavelength λ_{G} is transmitted to the photodetector 65 through this band-pass filter 61.

The band-pass filter 61 is configured (generated) by, for example, a dielectric multilayer film. This band-pass filter 61 has a transmission wavelength width of, for example, no less than 0.1 nm and no greater than 1 nm. FIG. 5 is a graph illustrating a transmission intensity of the band-pass filter 61. According to this example, a full width at half maximum of the transmission wavelength is about 0.4 nm. Production of the band-pass filter 61 of the dielectric multilayer film having the transmission wavelength width of no less than 0.1 nm is comparatively easy.

The second reference light transmitted through the band-pass filter 61 is received by the photodetector 65. Due to the presence of the band-pass filter 61, the photodetector 65 operates so as to output an electrical detection signal according to a reception intensity that exhibits a peak when the second reference light in other words, the wavelength-sweeping excitation light has a wavelength corresponding to the transmission wavelength range of the band-pass filter 61. The detection signal is converted through the output circuit 69 into a reference signal indicating that the wavelength being swept is the specified wavelength λ_{G} and input to the signal analysis unit 70.

That is, when the second reference light of the specified wavelength λ_{G} arising from the wavelength sweeping of the excitation light passes through the band-pass filter 61, the second reference light transmitted through the band-pass filter 61 is detected by the photodetector 65. At the photodetector 65, a current proportional to the transmitted light intensity is generated, and an electrical signal having this current information is input to the output circuit 69 as the detection signal.

The output circuit 69 converts the current information had by the input detection signal into voltage information. The output circuit 69 is further configured to generate the reference signal at an instant when a voltage of the converted detection signal exceeds a predetermined voltage. By this, the reference signal is output from the output circuit 69 when the excitation light reaches the specified wavelength λ_{G} by wavelength sweeping and is input to the signal analysis unit 70.

At a transmission wavelength width of no greater than 0.1 nm, there is significant intensity loss in light transmission. At a transmission wavelength width of no less than 1 nm, a slope of the transmission light intensity relative to the wavelength becomes gentle near the transmission wavelength; effects of intensity fluctuation of the light source, noise of an electrical circuit, and the like are greatly received; and variation in the wavelength output by the reference signal increases. Because of this, the transmission wavelength width of the band-pass filter 61 in one or more embodiments may be no less than 0.1 nm and no greater than 1 nm.

To stabilize temperature characteristics of a wavelength reference, the band-pass filter 61 of the reference-signal generation unit 60 may use a temperature regulating configuration including a heater or a Peltier element to control the temperature to be held at a certain temperature. The etalon 53 included in the k-clock interferometer 51 may likewise be temperature-controlled to be held at a constant temperature using a temperature regulating configuration. An output-power fluctuation amount of the excitation light generated when wavelength sweeping may be monitored through monitoring an amplitude of the interference signal, and the detection signal from the photodetector 65 may be corrected so as to cancel out an effect of this optical output-power fluctuation amount. The optical splitting at the optical splitter 40 illustrated in FIG. 1 may be changed to three-way splitting, and in addition to the reference-signal generation unit 60 and the equal-wavenumber-signal generation unit 50, an intensity-reference generation unit may be newly provided as a part that receives this split signal. The intensity-reference generation unit may receive the split signal and output a signal representing the light intensity of the wavelength-sweeping light source. The signal analysis unit 70 simultaneously samples this signal together with the reference signal, the equal-wavenumber signal, and the intensity measurement signal and can use this to correct the signal intensity detected by the mid-infrared-light detection unit 30.

The reference-signal generation unit 60 of the above configuration is not affected by variation in the displacement of the MEMS diaphragm mirror even in an environment where such occurs at each wavelength sweep and can output the reference signal when the excitation light has the specified wavelength λ_{G}.

As a variation, the reference-signal generation unit 60 may be provided with a fiber Bragg grating (FBG) that reflects input light of a narrow wavelength band of no less than 0.1 nm and no greater than 1 nm instead of the band-pass filter 61. That is, the reference-signal generation unit 60 may be configured to receive the second reference light of the specified wavelength reflected by the FBG by the photodetector 65.

The signal analysis unit 70 is provided with a processor 71, a storage device 73 (recording unit), a data acquisition (DAQ) device 75, an operation device 77, and an output device 79. The DAQ device 75 is configured to sample the reference signal from the reference-signal generation unit 60, the equal-wavenumber signal from the equal-wavenumber-signal generation unit 50, and the intensity measurement signal from the mid-infrared-light detection unit 30 at equal time intervals to convert these signals into digital time-series data and record this time-series data in the storage device 73. Examples of the storage device 73 include a hard disk and a semiconductor memory such as a flash memory.

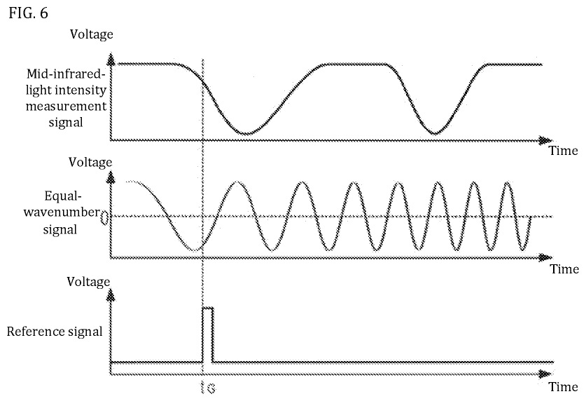

FIG. 6 illustrates examples of the intensity measurement signal from the mid-infrared-light detection unit 30, the equal-wavenumber signal (k-clock signal) from the equal-wavenumber-signal generation unit 50, and the reference signal from the reference-signal generation unit 60 in time-versus-voltage graphs with the horizontal axis as the temporal axis.

Specifically, the DAQ device 75 operates so as to sample the reference signal, the equal-wavenumber signal, and the intensity measurement signal at the same time. By this, the time-series data of the reference signal, the time-series data of the equal-wavenumber signal, and the time-series data of the intensity measurement signal are placed in a configuration of being associated with a common temporal axis, sampling data of the same time on this temporal axis being arranged at equal time intervals. So the reference signal, the equal-wavenumber signal, and the intensity measurement signal arising at the same wavelength are sampled simultaneously, a propagation length of light and a propagation length of electrical signals in the optical measurement system 1 are established. With the reference signal, the equal-wavenumber signal, and the intensity measurement signal, should there be a difference in optical transmission path lengths of propagation through optical fibers or a space, a difference in transmission speeds of electronic circuits that transmit optical signals, or a difference in lengths of transmission cables of the electrical signals that cause a clear difference in signal arrival time to the DAQ device 75 for each signal at a certain sweeping wavelength, by temporally shifting the sampling data of the equal-wavenumber signal and the intensity measurement signal sampled simultaneously by the DAQ device 75 relative to the sampling data of the reference signal, synchronicity of the reference signal, the equal-wavenumber signal, and the intensity measurement signal at a certain sweeping wavelength can also be adjusted.

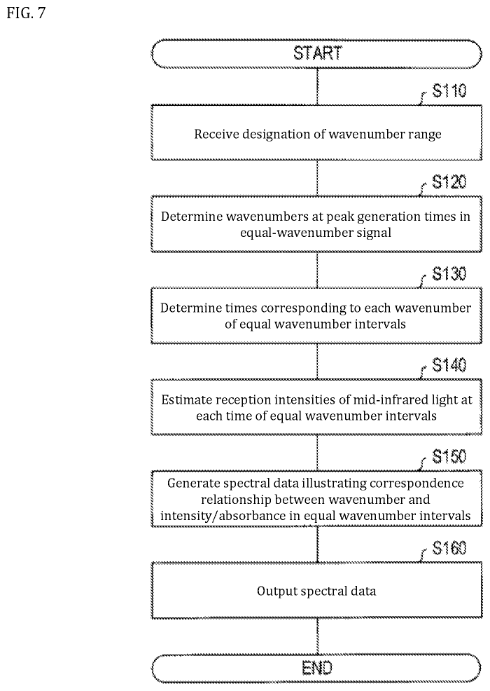

The processor 71 operates so as to process the time-series data of the reference signal, the time-series data of the equal-wavenumber signal, and the time-series data of the intensity measurement signal recorded in the storage device 73 to generate spectral data relating to optical absorption of the measurement target gas 20. Specifically, the processor 71 executes the analysis processing illustrated in FIG. 7 to generate the spectral data.

When the analysis processing is started, the processor 71 receives a designation of a wavenumber range to be analyzed from a user through the operation device 77 (S110). Afterward, the processor 71 refers to the time-series data of the reference signal and the time-series data of the equal-wavenumber signal to execute processing of determining wavenumbers of the excitation light and the mid-infrared light at times after the reference signal is input (S120).

A wavenumber 1/λᵢ of the mid-infrared light can be calculated according to formula (1) above from a wavenumber 1/λₛ of the signal light and a wavenumber 1/λₚ of the excitation light.

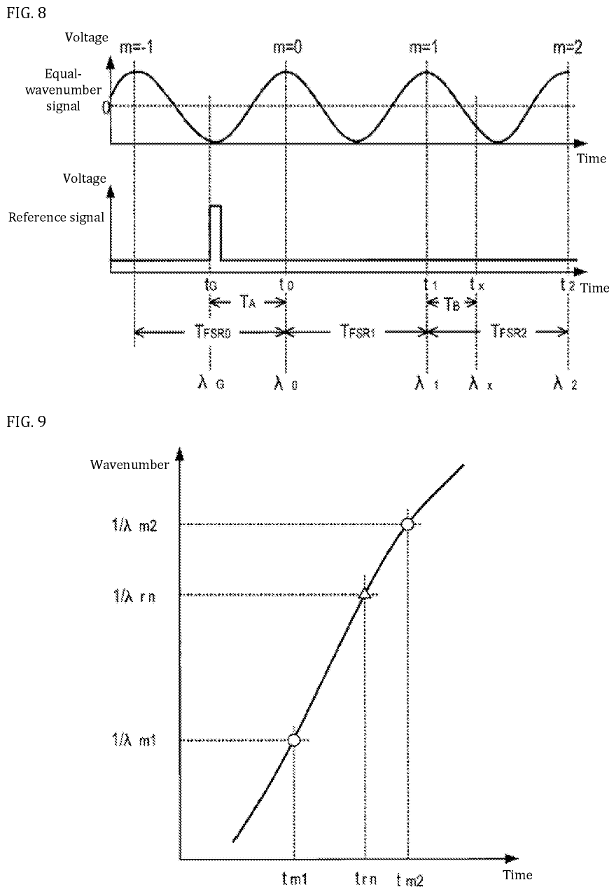

A wavenumber at a certain time of the excitation-light light source 12 that is the wavelength-sweeping light source can be calculated according to the following principle. As above, the equal-wavenumber signal (k-clock signal) is a voltage signal whose signal level increases and decreases in conjunction with the wavelength sweeping of the excitation light and exhibits peaks in equal wavenumber intervals. Here, as illustrated in FIG. 8, an identification number m of a peak of the equal-wavenumber signal is sequentially allocated in a time series, the identification number of a peak immediately after reference-signal generation being 0 (m=0). Hereinbelow, the peak of the identification number m is also expressed as an mth peak.

In an environment that generates the reference signal when the sweeping wavelength has the wavelength λ_{G}, when the wavelength of the excitation light is swept in a direction wherein the wavelength becomes longer (that is, a direction wherein the wavenumber becomes smaller), a wavenumber 1/λᵣₙ of the excitation light at a generation time tₘ of the mth peak of the equal-wavenumber signal can be calculated according to the following formula using the reference signal as an indicator.

$$[ Math . 2 ]$$

$$\frac{c}{{λ}_{m}} = \frac{c}{{λ}_{G}} - ( \frac{{T}_{A}}{{T}_{FSR 0}} + m ) {v}_{FSR}$$

Here, the time T_{FSB0} corresponds to a time interval from a generation time of a peak of the equal-wavenumber signal immediately prior to reference-signal generation (m=−1) to a generation time to of the zeroth peak of the equal-wavenumber signal immediately after reference-signal generation (m=0), and the time T_{A} corresponds to a time interval from a generation time t_{G} of the reference signal to the generation time to of the zeroth peak. c corresponds to the speed of light, and V_{FSR} corresponds to a frequency difference between the peaks.

A wavenumber 1/λₓ at a time tₓ between the mth peak and an m+1 th peak of the equal-wavenumber signal can also be calculated as follows by interpolation.

$$[ Math . 3 ]$$

$$\frac{c}{{λ}_{x}} = \frac{c}{{λ}_{m}} - ( \frac{{T}_{B}}{{T}_{FSR ( m + 1 )}} ) {v}_{FSR}$$

Here, the time T_{FSR(m+1)} corresponds to a time interval from the generation time of the mth peak to a generation time of the m+1th peak, and the time T_{B} corresponds to a time interval from the generation time tₘ of the mth peak to the time tₓ.

For example, the wavenumber 1/λₓ at the time tₓ between the first peak (m=1) and the second peak (m=2) can be calculated as in the following formula using a time interval t_{FSR2} from a generation time t₁ of the first peak to a generation time t₂ of the second peak and the time interval T_{B} from the generation time t₁ of the first peak to the time tₓ.

$$[ Math . 4 ]$$

$$\frac{c}{{λ}_{x}} = \frac{c}{{λ}_{1}} - ( \frac{{T}_{B}}{{T}_{FSR 2}} ) {v}_{FSR}$$

As above, according to the reference signal and the equal-wavenumber signal, the wavenumber 1/λₚ of the excitation light at each time can be determined and the wavenumber 1/λᵢ of the mid-infrared light can be determined from this wavenumber 1/λₚ of the excitation light and the wavenumber 1/λₛ of the signal light.

At step S120, the processor 71 follows the principle above to determine wavenumbers 1/λ₀, 1/λ₁, 1/λ₂, . . . 1/λₘ, 1/λ_{M-1}, and t_{M} of the excitation light and corresponding wavenumbers of the mid-infrared light at each peak generation time t₀, t₁, t₂, . . . tₘ, tₘ₋₁, and t_{M} from the generation time t_{G} of the reference signal and the generation times t₀, t₁, t₂, . . . , tₘ, t_{M-1}, and t_{M} of each peak of the equal-wavenumber signal specified from the time-series data of the reference signal and the time-series data of the equal-wavenumber signal, the frequency difference V_{FSR} between the peaks, and the generation wavelength λ_{G} of the reference signal. At S120, by further determining wavenumbers of the excitation light and the mid-infrared light at the time tₓ between the peaks, wavenumbers of the excitation light and the mid-infrared light at times corresponding to each sampling data of the time-series data may be determined.

At S130 that follows, the processor 71 determines times tᵣ₁, t^{r2}, . . . , tᵣₙ, . . . , t_{r(N-1)}, and t_{rN} when lights of wavenumbers 1/λ₁, 1/λᵣ₂, . . . , 1/_{λm}, . . . , 1/λ_{(N-1)}, and 1/λ_{rN}—defined by dividing by N a wavenumber range kₜₒₜₐₗ from the generation time t_{G} of the reference signal to an Mth peak of the equal-wavenumber signal corresponding to the wavenumber range designated at S110—are output from the wavelength-sweeping light source (excitation-light light source 12).

Here, the wavenumbers lined up in the equal wavenumber intervals kₜₒₜₐₗ/N from the wavenumber 1/λ_{G} at the time t_{G} when the reference signal is generated are expressed as 1/λᵣ₁, 1/λᵣ₂, . . . , 1/λᵣₙ, . . . , 1/λ_{r(N-1)}, and 1/λ_{rN} and times corresponding to each wavenumber 1/λᵣ₁, 1/λᵣ₂, . . . , 1/λᵣₙ, . . . , 1/λ_{r(N-1)}, and 1/λ_{rN} are expressed as tᵣ₁, tᵣ₂, . . . , tᵣₙ, . . . , t_{r(N-1)}, and t_{rN}. The time tᵣₙ corresponds to a time when light of the wavenumber 1/λᵣₙ is output from the wavelength-sweeping light source (excitation-light light source 12).

The wavenumber range kₜₒₜₐₗ is the wavenumber range [Mv_{FSR}/c+(t_{A}/t_{FSR0})v_{FSR}], a sum of a wavenumber range Mv_{FSR}/c from the zeroth peak to the Mth peak of the equal-wavenumber signal and a wavenumber range kₒₚ=(t_{A}/t_{FSR0})v_{FSR} from the generation time of the reference signal to the zeroth peak of the equal-wavenumber signal.

When a wavenumber range of a mid-infrared light is designated at S110, the processor 71 can set the above wavenumber range kₜₒₜₐₗ to include an excitement-light wavenumber range corresponding to this mid-infrared-light wavenumber range.

Among the wavenumbers 1/λᵣ₁, 1/λᵣ₂, . . . , 1/λᵣₙ, . . . , 1/λ_{r(N-1)}, and 1/λ_{rN} line up in the equal wavenumber intervals kₜₒₜₐₗ/N, the wavenumber 1/λ_{rN} that is nth from the wavenumber 1/λ_{G} is represented as follows. In the following, the wavenumber 1/λᵣₙ that is nth from the wavenumber 1/λ_{G} is also expressed as an nth 1/λᵣₙ.

1/λᵣₙ=1/λ_{G}+n(kₜₒₜₐₗ/N)

As illustrated in FIG. 9, when the nth wavenumber 1/λᵣₙ is between a wavenumber 1/λₘ₁ an m1th peak of the equal-wavenumber signal generated at a time tₘ₁ and a wavenumber 1/λₘ₂ of an m2th peak generated at a time tₘ₂, the time tᵣₙ corresponding to the nth wavenumber 1/λᵣₙ can be calculated according to the following formula.

$$[ Math . 5 ]$$

$${t}_{rn} = {t}_{m 1} + \frac{\vert 1 / {λ}_{rn} - 1 / {λ}_{m 1} \vert}{\vert 1 / {λ}_{m 2} - 1 / {λ}_{m 1} \vert} ( {t}_{m 2} - {t}_{m 1} )$$

At step S130, for this nth wavenumber 1/λᵣₙ, the processor 71 estimates two peaks of the equal-wavenumber signal interposing this wavenumber 1/λᵣₙ. Based on the times tₘ₁ and tₘ₂ corresponding to the wavenumbers 1/λₘ₁ and 1/λₘ₂ of these two peaks, light of the wavenumber 1/λᵣₙ is output from the wavelength-sweeping light source (excitation-light light source 12), and the time tᵣₙ when the corresponding mid-infrared light is irradiated to the measurement target is determined. This process is executed for the wavenumbers 1/λᵣ₁, 1/λᵣ₂, . . . , 1/λᵣₙ, . . . , 1/λ_{r(N-1)}, and 1/λ_{rN} to determine the corresponding times tᵣ₁, tᵣ₂, . . . , tᵣₙ, . . . , t_{r(N-1)}, and t_{rN}.

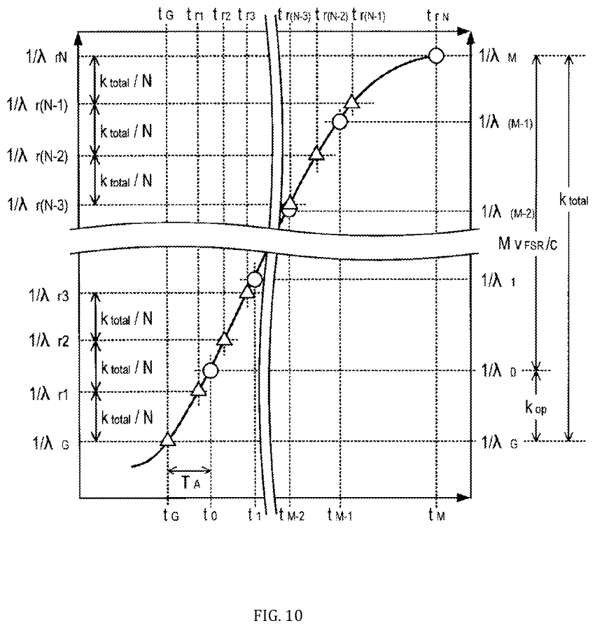

FIG. 10 illustrates as an explanatory diagram relating to rescaling a graph representing a correspondence relationship between time and wavenumber. In this graph, the vertical axis is a wavenumber axis and the horizontal axis is a temporal axis. In FIG. 10, the circles illustrate a correspondence relationship between the generation times ₀, t₁, t₂, . . . tₘ, tₘ₋₁, and t_{M} of each peak of the equal-wavenumber signal and the wavenumbers b 1/λ₀, 1/λ₁, 1/λ₂, . . . , 1/λᵣₙ, 1/λ_{M-1}, and t_{M} and the triangles illustrate a correspondence relationship between the wavenumbers 1/λ_{G}, 1/λᵣ₁, 1/λᵣ₂, 1/λᵣₙ, . . . , 1/λ_{r(N-)}, and 1/λ_{rN} and the times t_{G}, tᵣ₁, tᵣ₂, . . . , tᵣₙ, . . . , t_{r(N-1)}, and t_{rN}.

At S140 that follows, the processor 71 calculates intensity estimate values I(tᵣ₁), I(tᵣ₂), . . . , I(tᵣₙ), . . . , I(t_{r(N-1)}), and I(t_{rN}) of the mid-infrared light at the times tᵣ₁, tᵣ₂, . . . , tᵣₙ, . . . , t_{r(N-1)}, and t_{rN} based on the time-series data of the intensity measurement signal. These intensity estimate values I(tᵣ₁), I(tᵣ₂), . . . , I(tᵣₙ), . . . , I(t_{r(N-1)}), and I(t_{rN}) respectively correspond to intensity estimate values of the mid infrared light of the wavenumbers 1/λᵣ₁, 1/λᵣ₂, . . . , 1/λᵣₙ, . . . , 1/λ_{r(N-1)}, and 1/λ_{rN} passed through the measurement target gas 20.

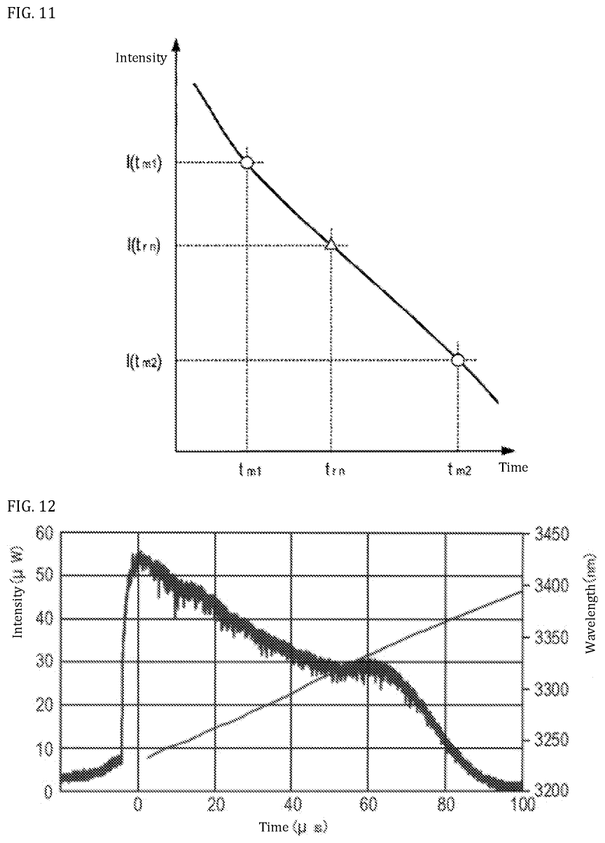

As illustrated in FIG. 11, the intensity estimate value I(tᵣₙ) of the time tᵣₙ can be calculated according to the following formula using linear interpolation from intensities I(tₘ₁) and I(tₘ₂) of the mid-infrared light measured at the times tₘ₁ and tₘ₂ adjacent to the time tᵣₙ specified from the time-series data of the intensity measurement signal sampled at equal time intervals.

$$[ Math . 6 ]$$

$$I ( {t}_{rn} ) = I ( {t}_{m 1} ) + ( I ( {t}_{m 2} ) - I ( {t}_{m 1} ) ) \frac{( {t}_{rn} - {t}_{m 1} )}{( {t}_{m 2} - {t}_{m 1} )}$$

At S140, the processor 71 calculates the intensity estimate values I(tᵣ₁), I(tᵣ₂), . . . , I(tᵣₙ,), . . . , I(t_{r(N-1)}), and I(t_{rN}) of the mid-infrared light at each wavenumber 1/λᵣ₁, 1/λᵣ₂, . . . , 1/λᵣₙ, . . . , 1/λ_{r(N-1)}, and 1/λ_{rN} in equal wavenumber intervals from the time-series data of the intensity measurement signal according to the above formula. Although in one or more embodiments the intensity estimate values are calculated by linear interpolation as above, low-degree spline interpolation up to the third degree may be used instead of linear interpolation.

In this manner, the processor 71, through steps S110 to S140 above, converts intensity information in equal time intervals indicated by the time-series data of the intensity measurement signal into intensity information in equal wavenumber intervals by a predetermined rescaling method. Note that although in one or more of the above embodiments rescaling is performed in a wavenumber range based on the reference signal, rescaling may be performed in a wavenumber range from the zeroth peak to the Mth peak of the equal-wavenumber signal.

At S150 that follows, the processor 71, based on the respective intensity estimate values I(tᵣ₁), I(tᵣ₂), . . . , I(tᵣₙ,), . . . , (t_{r(N-1)}), and I(t_{rN}) of the wavenumbers 1/λᵣ₁, 1/λᵣ₂, . . . , 1/λᵣₙ, . . . , 1/λ_{r(N-1)}, and 1/λ_{rN}, generates spectral data (intensity spectral data) representing a correspondence relationship between wavenumbers arranging intensity estimate values I(λ_{INF1}), I(λ_{INF2}), . . . , I(λ_{INFn}), . . . , I(λ_{INF(N-1)}), and I(λ_{INFN}) at wavenumbers 1/λ_{INF1}, 1/λ_{INF2}, . . . , 1/λ_{INFn}, . . . , 1/λ_{INF(N-1)}, and 1/λ_{INFN} of the mid-infrared light corresponding to the wavenumbers 1/λᵣ₁, 1/λᵣ₂, . . . , 1/λᵣₙ, . . . , 1/λ_{r(N-1)}, and 1/λ_{rN} and the light intensity passed through the measurement target gas 20. In addition to or instead of this intensity spectral data, spectral data (optical-absorption spectral data) representing a correspondence relationship between wavenumbers arranging absorbances A(λ_{INF1}), A(λ_{INF2}), . . . , A(λ_{INFn}), . . . , A(λ_{INF(N-1)}), and A(λ_{INFN}), at the wavenumbers 1/λ_{INF1}, 1/λ_{INF2}, . . . , 1/λ_{INFn}, . . . , 1/λ_{INF(N-1)}, and 1/λ_{INFN} of the mid-infrared light and the absorbance may be generated.

The wavenumber 1/λ_{INRn} of the mid-infrared light corresponding to the wavenumber 1/λᵣₙ of the excitation light can be easily calculated from formula (1) above. When an intensity estimate value calculated from a reception intensity of when the measurement gas is not present is made to be I₀(λ_{INFn}), the absorbance A(λ_{INFn}) at the wavenumber 1/λ_{INFn} can be calculated according to the formula

A(A_{INFn})=−log₁₀(I(λ_{INFn})/I₀(λ_{INFn})).

The storage device 73 can store in advance intensity distribution data indicating a correspondence relationship between the wavenumber and the light intensity of the mid-infrared light when the measurement target gas 20 is not present.

To reach calculating the absorbances A(λ_{INF1}), A(λ_{INF2}), . . . , A(λ_{INFn}), . . . , A(λ_{INF(N-1)}), and A(λ_{INFN}), information of the wavelength λₛ of the signal-light light source 11, the wavelength λ_{G} corresponding to the reference signal, and the frequency difference V_{FSR} between the peaks of the equal-wavenumber signal is necessary; as for this information, values measured using an optical spectral analyzer or the like can be stored in advance in the storage device 73.

At S160, the processor 71 outputs the generated spectral data. Specifically, the processor 71 can output to and save in the storage device 73 the generated spectral data. The processor 71 may output the spectral data through the output device 79. The output device 79 can be a display device such as a liquid-crystal display. In this situation, the processor 71 can output the generated spectral data to the user through the display device as a display image (graph) of the optical absorption spectrum.

FIG. 12 illustrates change over time in output intensity and wavelength of the mid-infrared light from the mid-infrared-light generation unit 10 when a DFB laser of 1.55 μm is used as the signal-light light source 11, a MEMS tunable VCSEL light source is used as the excitation-light light source 12, and the excitation light is swept in a wavelength range of 1.047 μm to 1.064 μm. The jagged line in FIG. 12 illustrates the output intensity of the mid-infrared light, and the gently sloping solid line in FIG. 12 illustrates the wavelength of the mid-infrared light. In this diagram, the reference signal is output at a time of 0 μs.

The intensity illustrated in FIG. 12 is sampled using the DAQ device 75 having a sampling frequency of 1 GHz. The wavelength-sweep repeating frequency in this example is 6 kHz, and wavelength sweeping of 160 nm (converted into wavenumber, 146 cm⁻¹) from a wavelength of 3,230 nm to 3,390 nm is realized in 100 μs.

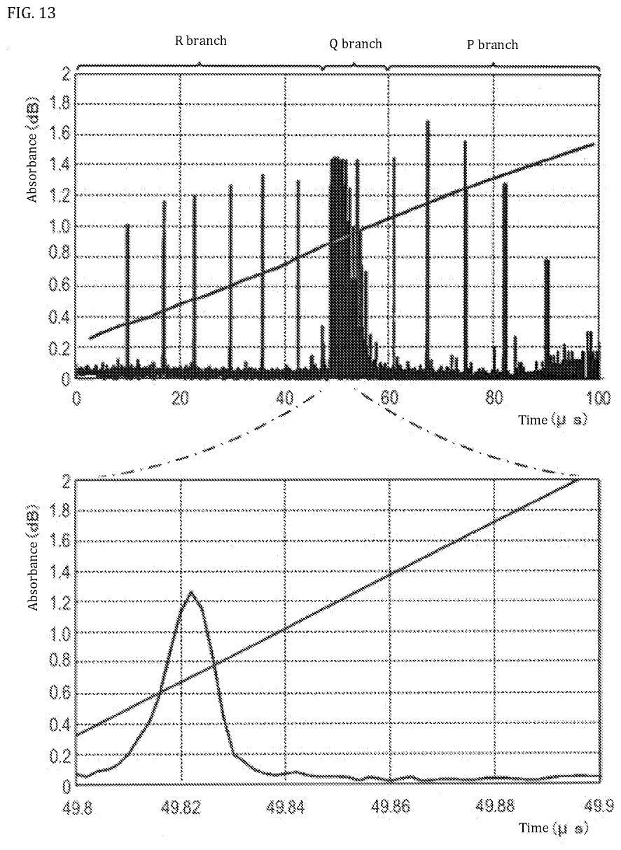

Results of measuring an absorbance of methane gas with the light sources and the wavelength sweeping according to this example are illustrated in FIG. 13. The lower part of FIG. 13 displays an enlarged partial region of the absorbance illustrated in the upper part of FIG. 13. This measurement was performed by enclosing methane gas) in a 10 cm long cell and irradiating a mid-infrared light to the methane gas enclosed in the cell, which had a temperature of 25° C. and a pressure of 10 Torr.

As is understood from FIG. 13, according to the optical measurement system 1 of one or more embodiments, each individual absorption line of the R branch and the P branch of C-H vibration of the methane gas was able to undergo clean resolution measurement. Moreover, the absorption lines of the Q branch, which has a finer structure, was also able to undergo clean resolution measurement. From this, it can be understood that the mid-infrared light has a sufficiently narrow linewidth for vibrational and rotational absorption-line measurement.

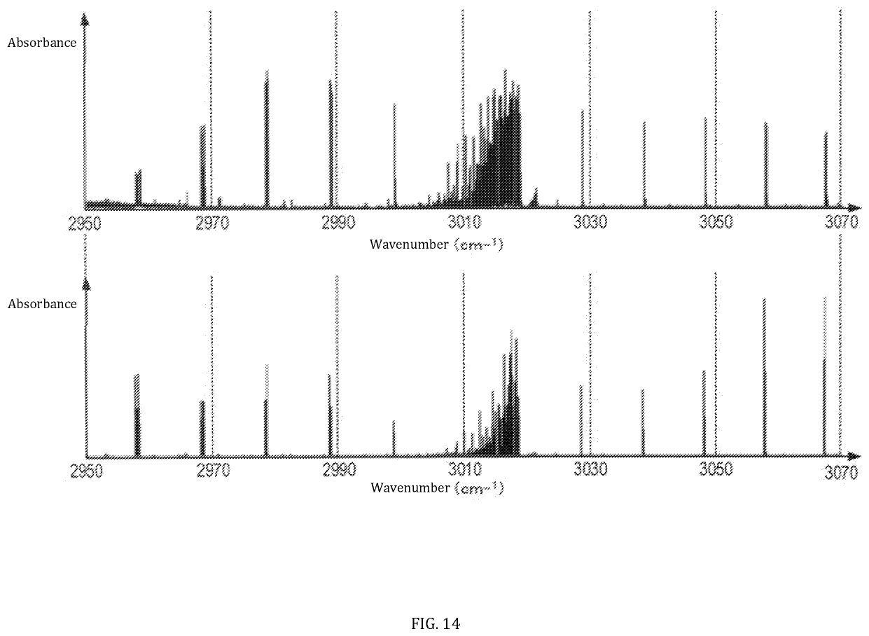

Furthermore, the upper part of FIG. 14 illustrates an optical absorption spectrum representing absorbances at each wavenumber at room temperature of the methane gas obtained using the optical measurement system 1 of one or more embodiments. Moreover, the lower part of FIG. 14 illustrates an optical absorption spectrum at room temperature of methane gas obtained by calculation using the HITRAN2012 database. By comparing these diagrams, it can be understood that the optical measurement system 1 of one or more embodiments can measure with high precision absorbance in a wavenumber range of 2,950 cm⁻¹ to 3,070 cm⁻¹.

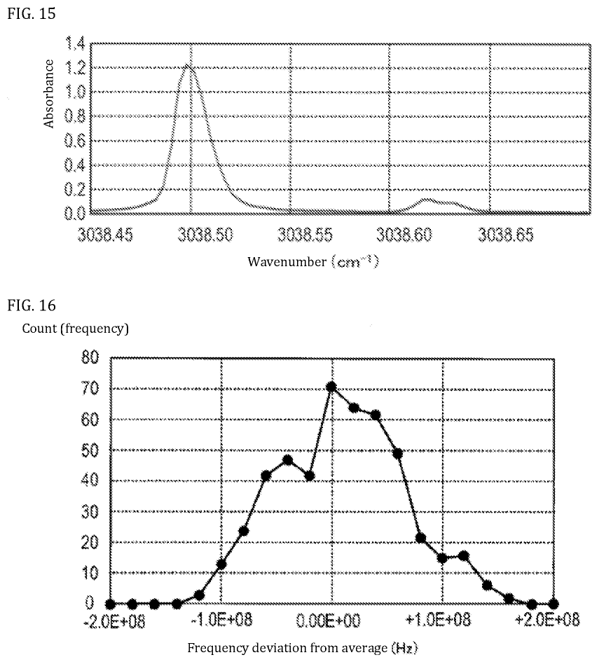

FIG. 15 is an enlarged graph of the absorbance near 3,038.5 cm⁻¹ among the large number of absorbance lines in the upper part of FIG. 14. The linewidth of the mid-infrared light is thought to be no greater than a linewidth corresponding to a width of this absorption line. It can be confirmed that a full width at half maximum of this absorption line is about 0.01 cm⁻¹. The linewidth of 0.01 cm⁻¹ is about 300 MHz converted into frequency, and from this measurement result, it can be understood that the linewidth of the mid-infrared light is no greater than 300 MHz. The linewidth of this mid-infrared light is a linewidth that is no greater than 1 GHz necessary to measure characteristic absorption lines of a molecule.

FIG. 16 illustrates results of measuring wavenumber variation of this absorbance peak. Specifically, it illustrates a frequency histogram of frequency variation of this absorbance peak in relation to the absorption line of 3,038.5 cm⁻¹ from data of 479 consecutive measurements using wavelength sweeping of a repeating frequency of 6 kHz.

A standard deviation of the repeating frequency is 57 MHz. This standard deviation of the repeating frequency is about 20% of a Doppler broadening width of methane gas at room temperature of 280 MHz, and one certain absorption line of room-temperature methane gas can be measured by the wavenumber variation in the absorption linewidth. The Doppler broadening of the methane gas can be calculated by the following formula.

$$[ Math . 7 ]$$

$${v}_{doppler} = \frac{2 \sqrt{ln ( 2 )}}{{λ}_{d}} \sqrt{\frac{2 {k}_{B} T}{m}}$$

Here, k_{B} is the Boltzmann constant, T is an absolute temperature, m is a mass of the gas molecules, and λ_{d} is the wavelength of the light used in absorption measurement.

When the wavenumber variation of the mid-infrared light is able to be suppressed to within the width of one absorption line, able to be performed is, for example, real-time measurement of a methane-gas concentration. By subjecting measurement values of a plurality of times at the same wavenumber to integrating processing, it is also possible to increase a SN ratio of the optical absorption spectrum.

Because the light sources of one or more embodiments can perform measurement at a high repeating frequency, change over time in a concentration of the measurement target gas 20 can be monitored in real time. Defining a gas absorption sectional area of a certain wavelength as σ (cm²), the gas concentration as N (cm⁻³), and the mid-infrared light intensity as I(x), the intensity of the mid-infrared light when being propagated in an x direction can be represented by the following formula in a differential form.

$$[ Math . 8 ]$$

$$\frac{dI}{dx} = - N σ I ( x )$$

Defining the light intensity prior to incidence to the measurement target gas 20 as I₀, the light intensity when the mid-infrared light is being propagated in a gas of a uniform concentration by a distance x is represented according to the following formula.

I(x)=I₀exp(−Nσx) [Math. 9]

In this manner, the light intensity attenuates exponentially. Because the absorption sectional area σ is a numerical value unique to a molecule, when the distance x is determined, the molecular concentration N of the measurement target can be sought by calculation. By measuring the change over time in the light output intensity I(x) at a specified wavenumber, the change over time in the gas concentration can be measured.

Wavelengths whereat absorption lines appear differ according to molecule type. By analyzing the wavelengths whereat these absorption lines appear, it is also possible to specify the types of mixed gases. Because the light sources of one or more embodiments cover a wide mid-infrared wavelength range, mixture ratios of various molecular species can be measured.

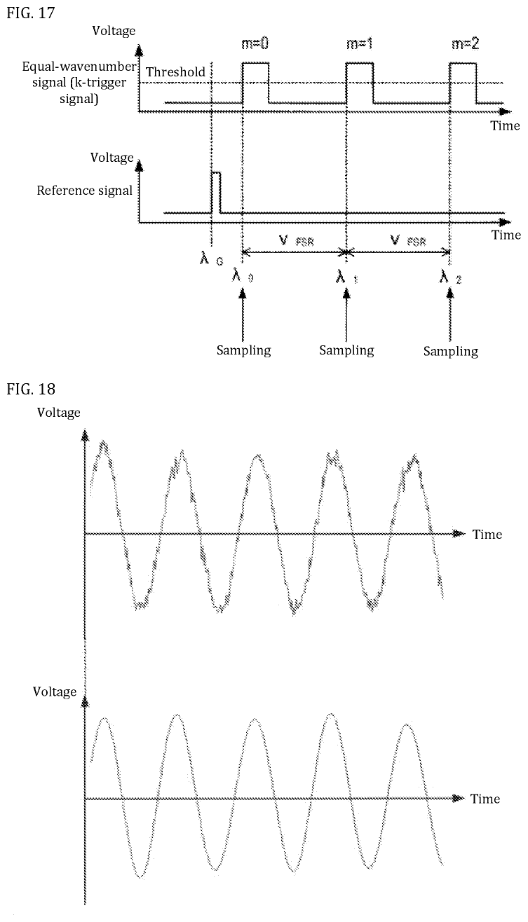

According to one or more embodiments described above, each signal is sampled at equal time intervals. However, the DAQ device 75 may sample each signal at equal wavenumber intervals using a k-trigger sampling method. That is, the DAQ device 75 can generate reception-intensity data in equal wavenumber intervals by sampling the intensity measurement signal at timings when the k-trigger signal crosses a reference voltage. FIG. 17 illustrates the reference signal and the k-trigger signal on a common temporal axis.

In this example, the wavelength (wavenumber) of the mid-infrared light corresponding to the sampled reception intensity can be determined from the generation wavelength λ_{G} of the reference signal and the wavelength (wavenumber) of when the k-trigger signal exceeds a threshold.

Additionally, because the detected interference signal includes variation in light output intensity and noise, times shifted from the actual equal wavenumber intervals can be detected as the peak generation times of the equal-wavenumber signal. Because of this, the processor 71 may apply numerical-computation filter processing to the time-series data of the equal-wavenumber signal sampled by the DAQ device 75, remove the noise component from the time-series data of the equal-wavenumber signal thereby, and determine the generation times of each peak based on the time-series data of the equal-wavenumber signal removed of the noise component. The time-series data of the equal-wavenumber signal removed of the noise component improves wavenumber determination precision.

The upper part of FIG. 18 illustrates the equal-wavenumber signal before executing the numerical-computation filter processing, and the lower part of FIG. 18 illustrates the equal-wavenumber signal after executing the numerical-computation filter processing.

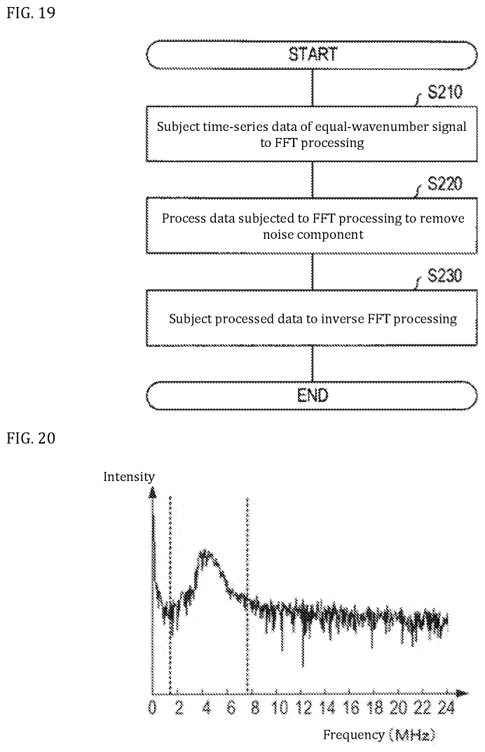

As illustrated in FIG. 19, the numerical-computation filter processing includes a step (S210) of executing FFT (fast-Fourier-transform) processing on the time-series data of the equal-wavenumber signal, a step (S220) of processing the data values subjected to the FFT processing (Fourier-transform values) to be removed of a noise component by replacing components other than a target frequency component with values significantly smaller than the target frequency component after the data values are FFT processed (Fourier-transform values), and a step (S230) of executing inverse FFT processing on the processed data to generate time-series data of the equal-wavenumber signal removed of the noise component.

By executing the numerical-computation filter processing illustrated in FIG. 19 before executing the processing of S120 in the analysis processing (FIG. 7), the processor 71 can generate the time-series data of the equal-wavenumber signal removed of the noise component and use this data to execute processing of S120 and beyond.

FIG. 20 represents a frequency spectrum of when the FFT processing is executed for the time-series data of the equal-wavenumber signal illustrated in the upper part of FIG. 18. According to FIG. 20, the equal-wavenumber signal has a frequency component having a peak near 4 MHz. The lower part of FIG. 18 illustrates the equal-wavenumber signal when components other than the component interposed by the dashed lines before and after the peak frequency illustrated in FIG. 20 are replaced with very small values to the signal and inverse 1-1-T processing is performed. Substitution can be realized by causing a very small coefficient that is less than 1 to act on the data values after the FFT processing (Fourier-transform value). As another example, the numerical-computation filter processing may use a FIR (finite impulse response) filter where phase information of a waveform after filter processing does not shift.

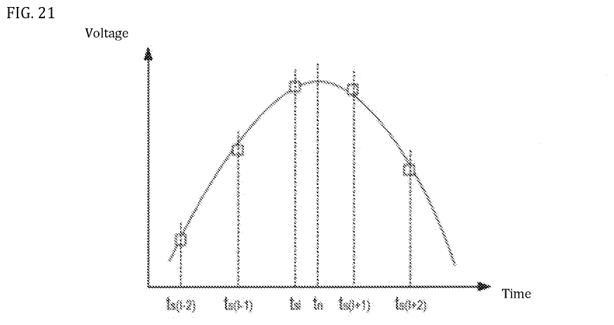

Peak detection in the equal-wavenumber signal may be realized by function fitting. Function fitting may be realized by using a least-squares method. For example, as illustrated in FIG. 21, no fewer than three and no greater than 1,000 consecutive data points (for example, tₛ₍₁₋₂₎, tₛ₍₁₋₁₎, tₛ₁, tₛ₍₁₊₁₎, and tₛ₍₁₊₂₎) may be extracted from data generated by subjecting the equal-wavenumber signal to equal-time sampling, the extracted data may be fitted by a least-squares method by a quadratic function, and a time corresponding to a peak of the quadratic function may be estimated as a peak time tₙ of the equal-wavenumber signal.

The present invention is not limited to the above embodiments and can adopt various other forms.

For example, in one or more of the above embodiments, each peak of the equal-wavenumber signal is used as an indicator of the equal wavenumber intervals, but times when the interference signal exceeds an amplitude center voltage level of the interference signal may be used as the indicator of the equal wavenumber intervals. In one or more of the above embodiments, the spectral data of wavenumber versus intensity/absorbance is generated by determining wavenumbers, but instead of determining wavenumbers, wavelengths may be determined to generate spectral data of wavelength versus intensity/absorbance or frequencies may be determined to generate spectral data of frequency versus intensity/absorbance.

Additionally, one or more of the above embodiments describe wavelength sweeping in a wavelength range centered around 3.3 um with measurement of methane gas as an example, but by changing the wavelengths of the signal light and the excitation light and a design of the nonlinear optical material, wavelength sweeping in wavelength ranges centered around 3.1 μm or 3.4 μm is also possible, and the wavelength range of the mid-infrared light (difference-frequency light) may be adjusted within a range of 3 μm to 3.5 μm.

To measure the absorption lines, the linewidth of the mid-infrared light can be established in a range of no less than 1 MHz and no greater than 1 GHz. The wavelength-sweep repeating frequency of the difference-frequency light is meaningful when established to be no less than 10 Hz, which is higher than is the case conventionally. Specifically, it is favorable to establish the wavelength-sweep repeating frequency of the difference-frequency light to be no less than 10 Hz and no greater than 100 kHz. It is favorable to establish a sweeping wavenumber range to be no less than 20 cm⁻¹ and no greater than 250 cm⁻¹ for gas spectrometry.

A function had by one component in one or more of the above embodiments may be provided dispersed among a plurality of components. Functions had by a plurality of components may be integrated in one component. A portion of the configuration of one or more of the above embodiments may be omitted. At least a portion of the configuration of one or more of the above embodiments may be added to or replaced with another configuration of one or more of the above embodiments. All aspects included in the technical idea specified from the wording of the claims are embodiments of the present invention.

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

### REFERENCE SIGNS LIST

1 . . . optical measurement system, 10 . . . mid-infrared-light generation unit, 11 . . . signal-light light source, 12 . . . excitation-light light source, 13 . . . optical amplification device, 14 . . . optical multiplexer, 15 . . . wavelength conversion element, 17 . . . condenser lens, 19 . . . optical splitter, 20 . . . measurement target gas, 30 . . . mid-infrared-light detection unit, 35 photodetector, 39 . . . output circuit, 40 . . . optical splitter, 50 . . . equal-wavenumber-signal generation unit, 52 . . . collimator lens, 53 . . . etalon, 54 . . . collimator lens, 55 . . . photodetector, 59 . . . output circuit, 60 . . . reference-signal generation unit, 61 . . . band-pass filter, 65 photodetector, 69 . . . output circuit, 70 . . . signal analysis unit, 71 . . . processor, 73 . . . storage device, 75 . . . DAQ device, 77 . . . operation device, 79 . . . output device.

What is claimed is:

1. An optical system, comprising:
a difference-frequency-light generator that:
multiplexes output lights from a signal-light light source and an excitation-light light source, and
inputs the output lights to a nonlinear optical material to generate and output a difference-frequency light having a wavenumber that corresponds to a wavenumber difference between light from the signal-light light source and light from the excitation-light light source, wherein
one of the signal-light source or the excitation-light source is a wavelength-sweeping light source;
a splitter that splits a portion of light output from the wavelength-sweeping light source into a first reference light and a second reference light;
an equal-wavenumber-signal generator that receives the first reference light, via an interferometer, to generate and output an equal-wavenumber signal that fluctuates in equal wavenumber intervals according to wavelength sweeping of the wavelength-sweeping light source, wherein the interferometer outputs an interference light that corresponds to a wavelength of light input to the interferometer; and
a reference-signal generator that receives the second reference light, via an optical element, to generate and output an electrical reference signal when the second reference light has a specified wavelength, wherein
the optical element selectively causes light with the specified wavelength, among light input into the optical element, to pass through the optical element.

2. The optical system of claim 1, further comprising:
a photodetector that detects the difference-frequency light from a measurement target and outputs a measurement signal that indicates a reception intensity of the difference-frequency light that passed through the measurement target; and
a recorder that records the measurement signal, the equal-wavenumber signal, and the electrical reference signal in association with a common temporal axis.

3. The optical system of claim 1, further comprising:
a photodetector that detects the difference-frequency light from a measurement target and outputs a measurement signal that indicates a reception intensity of the difference-frequency light that passed through the measurement target; and
an analyzer that determines a correspondence relationship between the reception intensity and a wavelength or the wavenumber of the difference-frequency light based on the measurement signal, the equal-wavenumber signal, and the electrical reference signal.

4. The optical system of claim 2, further comprising:
an analyzer that determines a wavelength or a wavenumber of the light output from the wavelength-sweeping light source or the difference-frequency light at times on the temporal axis based on the recorded equal-wavenumber signal and the recorded electrical reference signal.

5. The optical system of claim 4, wherein
the analyzer, based on the reception intensity at each time specified from the recorded measurement signal and the determined wavelength or wavenumber at the each time, generates data that indicates a correspondence relationship between the wavelength or the wavenumber and the reception intensity or an absorbance of light that passed through the measurement target.

6. The optical system of claim 3, wherein
the analyzer subjects the equal-wavenumber signal to filter processing to reduce a noise component included in the equal-wavenumber signal.

7. The optical system of claim 1, wherein
the wavelength-sweeping light source is a MEMS (microelectromechanical system) tunable VCSEL (vertical-cavity surface-emitting laser) that realizes the wavelength sweeping by driving one face of a reflecting mirror that forms part of a cavity in the MEMS tunable VCSEL by a MEMS of the MEMS tunable VCSEL.

8. The optical system of claim 1, wherein
the difference-frequency light is a mid-infrared light.

9. The optical system of claim 1, wherein
a wavelength of the difference-frequency light is within a mid-infrared wavelength range of 3 to 3.5 μm.

10. The optical system of claim 8, wherein
a linewidth of the difference-frequency light is no less than 1 MHz and no greater than 1 GHz.

11. The optical system of claim 8, wherein
a wavelength-sweep repeating frequency of the difference-frequency light is no less than 10 Hz and no greater than 100 kHz, and
a sweeping wavenumber range of the difference-frequency light is no less than 20 cm⁻¹ and no greater than 250 cm⁻¹.

12. The optical system of claim 8, wherein
the optical element is a dielectric multilayer film having an optical filter with a transmission wavelength width of no less than 0.1 nm and no greater than 1 nm.
